(19) United States
(12) Patent Application Publication
(10) Pub. No.: US 2015/0073859 A1
(43) Pub. Date: Mar. 12, 2015

(54) SYSTEM AND METHOD FOR ASSESSING TOTAL REGULATORY RISK TO HEALTH CARE FACILITIES

(71) Applicant: KONINKLIJKE PHILIPS N.V., EINDHOVEN (NL)

(72) Inventors: Saeed Reza Bagheri, Croton on Hudson, NY (US); Vikrant Suhas Vaze, White Plains, NY (US); Hanqing Cao, Mahwah, NJ (US); Charles Lagor, Wayland, MA (US); Ana Ivanovic, Eindhoven (NL)

(73) Assignee: KONINKLIJKE PHILIPS N.V., EINDHOVEN (NL)

(21) Appl. No.: 14/191,936

(22) Filed: Feb. 27, 2014

Related U.S. Application Data
(60) Provisional application No. 61/769,782, filed on Feb. 27, 2013.

(51) Int. Cl. G06Q 10/06

(52) U.S. Cl. CPC G06Q 10/0635; G06Q 50/22
USPC 705/7.28

(57) ABSTRACT

A medical system (10) and method (50) calculate holistic financial risks to caregiving facilities. Healthcare data for a caregiving facility is received. A first set of one or more key performance indicators (KPIs) is received relating regulatory data to financial risk to the caregiving facility from government regulations. A second set of one or more KPIs is received relating non-regulatory data to financial risk to the caregiving facility from one or more sources other than government regulations. The first and second sets of KPIs are simultaneously applied to the healthcare data to determine a net risk from both government regulations and other sources of financial risk.

The following relates generally to clinical decision making. It finds particular application in conjunction with managing financial risk in healthcare systems and will be described with particular reference thereto. However, it is to be understood that it also finds application in other usage scenarios and is not necessarily limited to the aforementioned application.

Managing financial risk has been a key focus in almost all businesses for decades. However, as the complexity of business increases, financial risk analysis and management is expected to become more challenging. This is particularly challenging in the healthcare industry due to changing government mandates. Financial risk analysis addresses financial risk from a variety of points of view, such as government regulation and reimbursement points of view, disease or clinical points of view, operational points of view, and overall enterprise points of view.

The rapid change of regulations in the healthcare industry is bringing a new dimension for consideration on all financial decisions by executives running care giving facilities. These changes, while not mandatory, by design target various financial facets of care giving facilities to motivate compliance with change. This requires a new perspective to financial risk analysis that not only brings together and combines previous views towards financial risk analysis in the healthcare industry (e.g., clinical, enterprise, operational, etc.), but also adds the regulation compliance aspect to create a holistic view towards risk analysis and to provide actionable mitigating recommendations.

The following provides new and improved methods and systems which overcome the above-referenced problems and others.

In accordance with one aspect, a medical system to calculate holistic financial risks to caregiving facilities is provided. The medical system includes at least one processor. The at least one processor is programmed to receive healthcare data for a caregiving facility, a first set of one or more key performance indicators (KPIs) relating regulatory data to financial risk to the caregiving facility from government regulations, and a second set of one or more KPIs relating non-regulatory data to financial risk to the caregiving facility from one or more sources other than government regulations. Further the at least one processor is programmed to simultaneously apply the first and second sets of KPIs to the healthcare data to determine a net risk from both government regulations and other sources of financial risk.

In accordance with another aspect, a method to calculate holistic financial risks to caregiving facilities is provided. Healthcare data for a caregiving facility is received. A first set of one or more key performance indicators (KPIs) relating regulatory data to financial risk to the caregiving facility from government regulations is received. A second set of one or more KPIs relating non-regulatory data to financial risk to the caregiving facility from one or more sources other than government regulations is received. The first and second sets of KPIs are simultaneously applied to the healthcare data to determine a net risk from both government regulations and other sources of financial risk.

In accordance with another aspect, a medical system to calculate holistic financial risks to caregiving facilities is provided. The medical system includes a source database including available healthcare data for the present time, a historical database including historical instances of the healthcare data of the source database, one or more key performance indicators (KPIs) relating various data from the source database and/or the historical database to financial outcomes, and a set of actions controlling the one or more KPIs.

One advantage resides in the simultaneous analysis of financial risk due to government regulations with at least one other type of financial risk, such as clinical or operational risk.

Another advantage resides in providing actionable mitigating recommendations to reduce financial risk.

Still further advantages of the present invention will be appreciated to those of ordinary skill in the art upon reading and understanding the following detailed description.

The invention may take form in various components and arrangements of components, and in various steps and arrangements of steps. The drawings are only for purposes of illustrating the preferred embodiments and are not to be construed as limiting the invention.

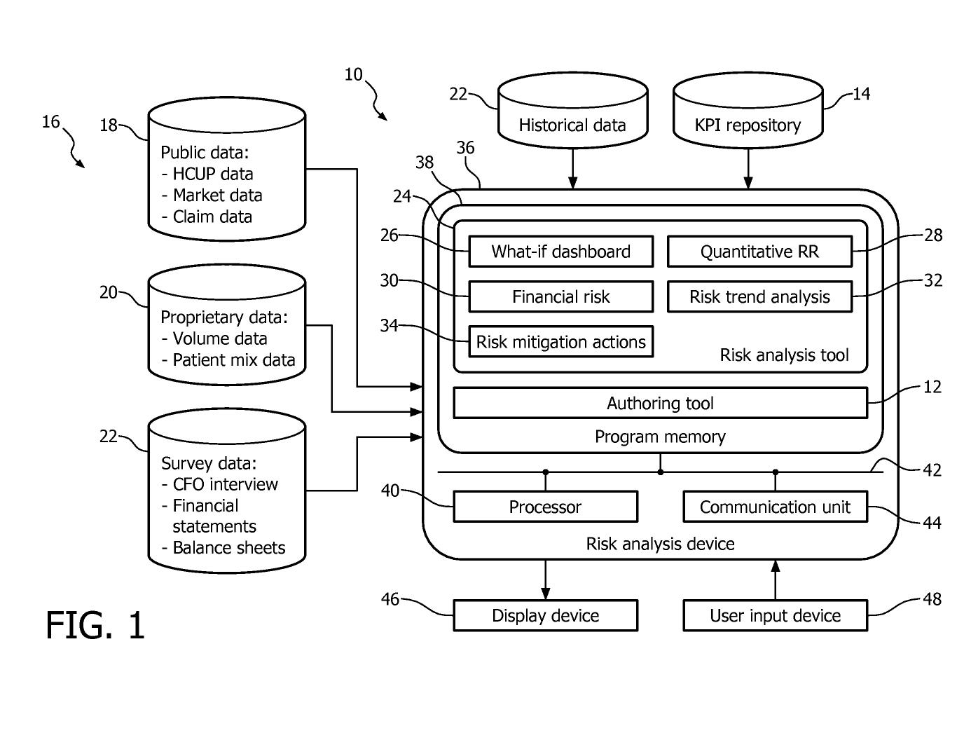

FIG. 1 illustrates a medical system for assessing regulation risk to care giving facilities.

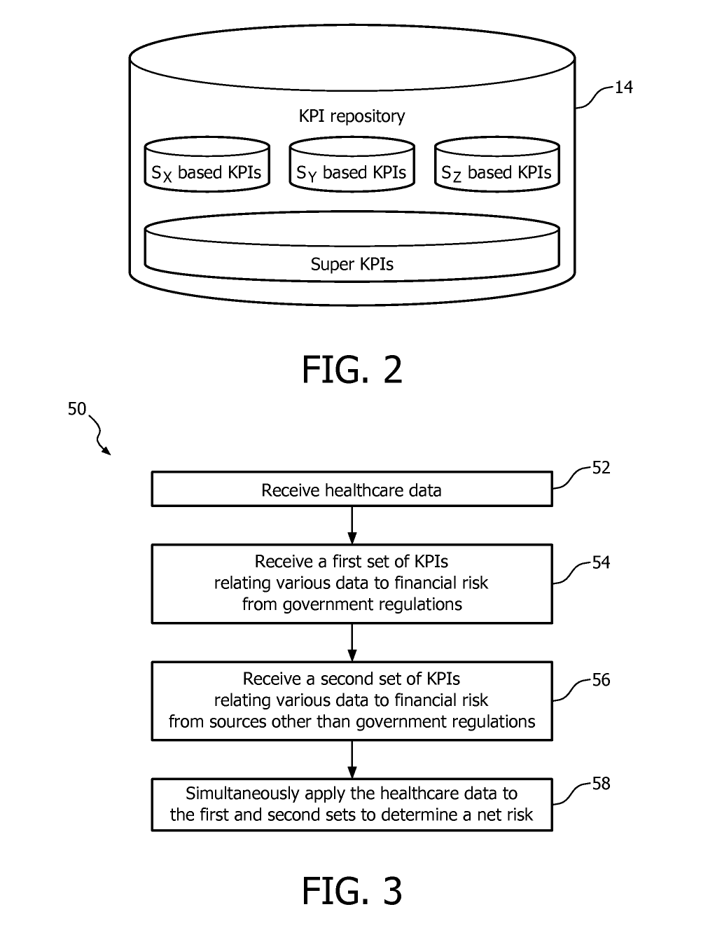

FIG. 2 illustrates an enhanced view of the key performance indicator (KPI) repository database of FIG. 1.

FIG. 3 illustrates a medical method for assessing regulation risk to care giving facilities.

Some of the main concerns of healthcare executives are financial challenges and healthcare reforms (e.g., government mandates). These challenges constantly present different options to healthcare executives. Two of the key aspects for any option in the eyes of healthcare executives are the short and long term financial implications of these options. However, the complexity of these options and their interrelation with several other domains (e.g., information technology, legal regulations, incentives, etc.) make these aspects dependent on the specific details and situations of each healthcare enterprise.

The present application uses various (internal and external) data sources, along with an improved approach to analyzing this data, to calculate the impact of government regulations on a caregiving facility. Such government risk can include, for example, risk from readmission, patient experience, quality of care, and the like. Namely, the government imposes penalties on caregiving facilities with poor readmission rates, patient experience, quality of care, and the like, while providing rewards to caregiving facilities with good readmission rates, patient experience, quality of care, and the like. A key feature of the present invention is the simultaneous analysis of hospital financial risk, government regulations (e.g., risk from readmission, patient experience, quality of care, and the like), and clinical risk to recommend mitigating actions.

With reference to FIG. 1, a medical system 10 for assessing regulation risk to a care giving facility, such as a hospital, using flat financial key performance indicators (KPIs) is provided. The regulation risk is typically assessed simultaneous with other types of risk facing the caregiving facility, such as clinical risk, operational risk and enterprise risk. KPIs are probability density functions (PDFs) directly relating money over time to a variety of different types of data, such as public data, proprietary data, and survey data. KPIs directly relating money over time to multiple types of data are referred to as super KPIs.

A KPI relating money over time to one or more different types of data can be defined using a function f(\vec{d}₁, . . . , \vec{d}ₘ, t, ξ), where \vec{d}₁, . . . , \vec{d}ₘ represent m≧1 different types of data, t represents time and ξ represents the actual values taken by the KPI. The function f(\vec{d}₁, . . . , \vec{d}ₘ, t, ξ) can be defined as a probability density function (PDF), S_{d}_{₁}× . . . ×S_{d}_{ₘ}× [symbol] ⁺× [symbol] → [symbol] ⁺, where S_{d}_{₁}, . . . , S_{d}_{ₘ} represent the data spaces for the different types of data, [symbol] represents all real numbers and [symbol] ⁺ represents all non-negative real numbers. To illustrate, a super KPI relating money over time to public data, proprietary data, and survey data can be defined as a function f(\vec{x}, \vec{y}, \vec{z}, t, ξ), where \vec{x}, \vec{y}, and \vec{z} represent public data, proprietary data and survey data, respectively, and t and ξ are as above. The function f(\vec{x}, \vec{y}, \vec{z}, t, ξ) can be defined as a PDF, Sₓ×S_{y}×S_{z}× [symbol] ⁺× [symbol] → [symbol] ⁺, where Sₓ, S_{y} and S_{z} represent the public data space, the proprietary data space and the survey data space, respectively.

KPIs are specifically generated for the care giving facility. As noted above, KPIs are PDFs directly relating money over time to a variety of data. Hence, KPIs are generated to relate the different types of data available to care giving facility to money over time. In certain instances, care giving facilities can share KPIs, such as when the caregiving facilities have access to the same type of data. To facilitate the generation of KPIs, the medical system 10 can include an authoring tool 12 allowing a user of the medical system 10 to generate KPIs. For example, the authoring tool 12 can provide a graphical user interface with graphical functions to facilitate the generation of KPIs.

An example KPI from the government readmission regulation domain can be defined with the following function:

$$f ( \vec{x} , \vec{y} , \vec{z} , t , ξ ) = \{ \begin{matrix}\frac{1}{\sqrt{2 π}} {e}^{- {( ξ - \frac{{ay}_{i}}{{x}_{i}} {x}_{i + 3} )}^{2} / 2} , & \frac{{ay}_{j}}{{x}_{i}} > {x}_{i + 1} \\ \frac{1}{2 π} {e}^{- {( ξ - \frac{{x}_{i}}{{by}_{j}} {x}_{i + 4} )}^{2} / 2} , & \frac{{ay}_{j}}{{x}_{i}} < {x}_{i + 2} \\ δ ( ξ ) , & o . w .\end{matrix} , ∀ t \qquad ( 1 )$$

where \vec{x}, \vec{y}, \vec{z}, t, and ξ are as above, yⱼ represents the hospital specific readmission rate for a specific diagnosis related group (DRG), j is the index of the specific DRG, different x values represent constants provided by public data to calculate the penalty or reward for readmission rates, and a and b are the KPI parameters. Specifically, with regard to x, xᵢ represent a readmission normalization constant, i=1, xᵢ₊₁ and xᵢ₊₂ represent the lower and upper limits of normalized readmission to qualify for penalty and reward, respectively, and x₁₊₃ and xᵢ₊₄ represent the penalty and reward coefficients, respectively (where sgn(xᵢ₊₃)*sgn(xᵢ₊₄)). Finally, δ(.) represents the dirac delta function. As should be appreciated, this example KPI is a super KPI in that it covers Sₓ and S_{y}.

In some instances, KPIs can include sets of mitigating actions A that change the parameters of the KPIs through predetermined models. For example, after performing one of the mitigating actions of a KPI, the parameters of the KPI can be updated in accordance with the predetermined model of the mitigating action. In this way, the KPIs can evolve and change over time, for example, as mitigating actions are performed by the caregiving facility. As will be appreciated, the sets of mitigating actions can be used to provide actionable mitigating recommendations.

The medical system 10 includes a KPI repository database 14 storing all the KPIs at the current time. As will be seen, parameters of the KPIs can change over time. Referring to FIG. 2, an enhanced view of the KPI repository database 14 is illustrated. As can be seen, the KPI repository database 14 includes KPIs defined for only one type of data. Namely, the KPI repository database 14 includes KPIs defined for only public data (i.e., Sₓ based KPIs), KPIs defined for only proprietary data (i.e., S_{y} based KPIs) and KPIs defined for only survey data (i.e., S_{z} based KPIs). The KPI repository database 14 further includes super KPIs, for example, combining KPIs for only one type of data.

Referring back to FIG. 1, the medical system 10 further includes source databases 16 storing all available source data for the different types of data provided to the KPIs at the current time. As illustrated, the source databases 16 include a public data database 18 for Sₓ, a proprietary data database 20 for S_{y} and a survey data database 22 for S_{z}. Public data can include all, or a subset of, publicly available data covering healthcare market, healthcare operations, claims and demography. For example, public data can include, for example, various government data (e.g., healthcare cost and utilization project (HCUP) data,

Medicare claims data and market data). Proprietary data can include all, or a subset of, hospital specific data that is proprietary to the caregiving facility. For example, proprietary data can include caregiving facility data (e.g., volume data and patient mix data). Survey data can include all, or a subset of, structured and non-structured data collected through interviews, surveys and auditing of the caregiving facility. For example, survey data can include various financial and non-financial data acquired through administrative files and/or direct interviews (e.g., chief financial officer (CFO) interview, financial statements and balance sheets).

The medical system 10 can further include a historical data database 22 keeping instances of the source data, as well instances of the KPIs, at past times. Suitably, the historical data database 22 stores data for all past times. However, this may not be practical in some situations. Hence, the historical data database 22 can only store data, for example, going back a predetermined amount of time.

A risk analysis tool 24 of the medical system 10 applies KPIs (e.g., from the KPI repository database 14 and/or the historical data database 22) to data (e.g., from the source databases 16 and/or the historical data database 22). The risk analysis tool 24 can be automatically run (e.g., as new data becomes available) or manually run. Typically, the risk analysis tool 24 applies KPIs from the KPI repository database 14 to data from the source databases 16. The risk analysis tool 24 at each invocation calculates the aggregate net (positive or negative) risk R(t, ξ) faced by the caregiving facility using n≧1 KPIs. The KPIs suitably include KPIs assessing financial risk from government regulation and at least one other source of financial risk, such as clinical risk or operational risk. In some instances, a user of the medical system 10 can select the KPIs. The aggregate net risk R(t, ξ) is determined by aggregating the PDFs of the KPIs to arrive at a total PDF.

In one embodiment, to assess total regulation risk to the caregiving facility, the risk analysis tool 24 uses public data, proprietary data and survey data, typically from the source databases 16 or the historical data database 22. Further, the risk analysis tool 24 uses a plurality of super KPIs relating public data, proprietary data and survey data to money over time, such as the super KPI of Equation (1). Suitably, the super KPIs take into account regulatory risk and at least one other type of risk, such as clinical or enterprise risk. Based on these super KPIs and data, the risk analysis tool 24 determines the aggregate net risk R(t, ξ) is Each super KPI fᵢ is accompanied by a set of mitigation actions Aᵢ that change the parameters of the super KPI through predetermined models.

To aggregate the PDFs, any number of well-known approaches to combining the PDFs can be employed. However, the risk analysis tool 24 suitably does not simply add the numerical value of each risk component to arrive at the aggregate net risk. According to one approach for aggregating the PDFs, the moment domain (i.e., M domain) is employed. As noted above, this approach can only be employed to the extent that KPIs are defined using the s parameter.

According to this approach, all the PDFs of the KPIs fᵢ to be combined are transferred into the M domain (or its moment generating function) as follows.

M_{fi}(s)= [symbol] (e^{sF}^{ᵢ}) (2)

where Fᵢ is a random variable with the PDF of fᵢ(\vec{d}₁, . . . , \vec{d}ₘ, t, ξ) and s represents the moment generating variable. Then, to determine the net risk, the following equation is employed.

M_{R}(s)=Πᵢ₌₁ⁿ [symbol] (e^{sF}^{ᵢ}) (3)

After determining the net risk in the M domain, the inverse transform of Equation (2) is taken to give the PDF of net risk. The summary of this process is shown below, where “*” represents a convolution operation.

$$\begin{matrix}R ( t , ξ ) = {f}_{1 + … + n} ( {\vec{d}}_{1} , … , {\vec{d}}_{m} , t , ξ ) \\ = ( {f}_{1} ( {\vec{d}}_{1} , … , {\vec{d}}_{m} , t , ξ ) * … * {f}_{n} ( {\vec{d}}_{1} , … , {\vec{d}}_{m} , t , ξ ) )\end{matrix} \qquad ( 4 )$$

This approach to combining KPIs is particularly useful in real-life situations where different risk factors don't simply add up. For instance, the total risk may increase because the risk per patient has increased or because of competition the number of patients is going down. In these scenarios, some pieces of risk are counted multiple times if the risk factors are simply added together. Furthermore, if applicable, this approach to aggregating risk factors can be further extended to account for risk correlations to fully account for the joint distribution of different types of risks.

The risk analysis tool 24 includes modules for control of the generation of the net risk and/or post-processing of the net risk. A what-if dashboard module 26 allows calculation of the net risk PDF for various instances of KPI input data. For example, drawing on the example super KPI above, different instances of the databases for Sₓ, S_{y} and S_{z} can be employed. This covers both hospital internal data (i.e., part of S_{y}) as well as external data from public sources (i.e., part of Sₓ), among others. By using different instances of input data, the what-if module 26 allows the determination of the net risk PDF for different what-if scenarios. These what-if scenarios can be internal as well as external (e.g., run for other care giving facilities). Further, the what-if scenarios can be in the past, the present, or the future.

A quantitative risk return (RR) module 28 allows net risk to be post-processed and transformed to expected risk, standard deviation of risk, confidence bands, and the like using statistical techniques that are known to a person skilled in the art. A financial risk module 30 allows net risk to be post-processed and transformed to average revenue loss, confidence ranges, and the like. Note that in Equations (3) and (4) the independence assumption is independently made. However, as it is known to a person skilled in the art, the same approach can work for dependent KPIs using the respective joint probability distribution function. A risk trend analysis module 32 performs trend analysis on the net risk PDF to observe how a particular risk value, subset of risk values, or all the risk values in the net risk PDF evolve over time. As should be appreciated, the net risk PDF is a function of time, thereby making trend analysis possible.

A risk mitigation module 34 presents suggested mitigation actions to a user of the medical system 10. As noted above, KPIs can include corresponding sets of mitigating actions A={a₁ . . . a₁}. Mitigating actions are actions that can be taken by a care giving facility to reduce risk. In terms of KPIs, mitigating actions affect the set of zero or more parameters P each KPI includes. As can be seen in Equation (1), the set of parameters of the KPI include a and b. The impact of mitigating actions to risk is modeled through a set of parameters in the corresponding KPI. For example, the impact if a mitigating action can be modeled by P*=Iⱼ(aⱼ,P), where P* is the updated set of parameters and Iⱼ is a function modeling the effect of the mitigating action with index j on the set of parameters P. Mitigating actions can be suggested by optimizing over the set of all mitigating actions and considering the multiple parameters they impact to find the best suitable mitigating actions for reducing risk. These best suitable mitigating actions can then be presented to a user of the medical system 10.

The authoring tool 12 and/or the risk analysis tool 24 are distributed across one or more risk analysis devices 36 of the medical system 10, such as computers. Each of the risk analysis devices 36 includes at least one program memory 38 and at least one processor 40, the at least one program memory 38 including the processor executable instructions of the corresponding portion of the authoring tool 12 and/or the risk analysis tool 24 and the at least one processor 40 executing the processor executable instructions of the corresponding portion of the authoring tool 12 and/or the risk analysis tool 24.

Each of risk analysis devices 36 further includes at least one system bus 42 and at least one communication unit 44. The at least one system bus 42 interconnects the at least one processor 40, the at least one program memory 38, and the at least one communication unit 44, of the corresponding risk analysis devices 36 to allow communication between these components. The at least one communication unit 44 provides the at least one processor 40 of the corresponding risk analysis devices 36 an interface for communicating with external systems and/or devices. For example, where the medical system 10 includes a plurality of risk analysis devices 36, the plurality of risk analysis devices 36 can communicate using corresponding communication units 44.

The risk analysis devices 36 are further in communication with a display device 46 and a user input device 48. The display device 46 allows the risk analysis devices 36 to output, present, or display data to a user of the medical system 10. For example, the net risk PDF can be displayed to a user of the medical system 10. The user input device 48 allows the risk analysis devices 36 to receive input from a user of medical system 10. For example, the user can control the risk analysis tool 24 to carry out what-if scenarios.

With reference to FIG. 3, a medical method 50 for assessing regulation risk to a care giving facility, such as a hospital, using flat financial key performance indicators (KPIs) is provided. The medical method 50 is suitably performed by the risk analysis devices 36 and embodied by the risk analysis tool 24.

According to the method 50, healthcare data for a caregiving facility is received 52. The healthcare data is used as input to KPIs. Further, the healthcare data is typically received from the source databases 16 and/or the historical data database 22. However, other sources of healthcare data are contemplated. Suitably, the healthcare data includes public data (e.g., HCUP data, Medicare claims data and market data), proprietary data (e.g., volume data and patient mix data for the caregiving facility), and survey data (e.g., chief financial officer (CFO) interview, financial statements and balance sheets).

A first set of one or more KPIs are further received 54. The first set of KPIs relates various data to financial risk facing the caregiving facility from government regulations. For example, the first set can include a KPI modeling the financial risk to the caregiving facility due to the readmission rate. As noted above, government regulations impose financial penalties for high readmission rates and provide rewards for low readmission rates. Low and high readmission rates are defined using thresholds. The first set of KPIs is typically received from the KPI repository database 14 and/or the historical data database 22, but other sources are contemplated.

In addition to receiving the first set of KPIs, a second set of one or more KPIs are received 56. The second set of KPIs relates various data to financial risk facing the caregiving facility from one or more sources other than government regulations. These other sources of financial risk can include, for example, clinical risk, operational risk, overall enterprise risk, and the like. For example, the caregiving facility can face financial risk based on clinical mistakes due to law suits. The second set of KPIs is typically received from the KPI repository database 14 and/or the historical data database 22, but other sources are contemplated.

After receiving the sets of KPIs and the healthcare data, the first and second sets of KPIs are simultaneously applied 58 to the healthcare data to determine a net risk from both government regulations and other sources of financial risk. This is performed by applying the healthcare data individually to the KPIs of the first and second sets to determine financial risk for the individual KPIs. The individual risks are aggregated, for example, using the moment based approach described above and summarized by Equation (4) to determine the net risk.

In other embodiments, a medical system includes a module or unit performing each of the steps of the method 50. The modules or units can be implemented in hardware, software, or a combination of the two. For example, a module or unit for receiving the first set of KPIs can be implemented in hardware, the module or unit for receiving the second set of KPIs can be implemented in software, the module or unit for receiving healthcare data can be a combination of software and hardware, and the module or unit for applying the KPIs of the first and second sets can be hardware. Hardware can, for example, include a processor.

As used herein, a memory includes one or more of a non-transient computer readable medium; a magnetic disk or other magnetic storage medium; an optical disk or other optical storage medium; a random access memory (RAM), read-only memory (ROM), or other electronic memory device or chip or set of operatively interconnected chips; an Internet/Intranet server from which the stored instructions may be retrieved via the Internet/Intranet or a local area network; or so forth. Further, as used herein, a processor includes one or more of a microprocessor, a microcontroller, a graphic processing unit (GPU), an application-specific integrated circuit (ASIC), a field-programmable gate array (FPGA), and the like; a controller includes: 1) at least one memory with processor executable instructions to perform the functionality of the controller; and 2) at least one processor executing the processor executable instructions; a database includes a memory; a user output device includes a printer, a display device, and the like; and a display device includes one or more of a liquid crystal display (LCD), an light-emitting diode (LED) display, a plasma display, a projection display, a touch screen display, and the like.

The invention has been described with reference to the preferred embodiments. Modifications and alterations may occur to others upon reading and understanding the preceding detailed description. It is intended that the invention be construed as including all such modifications and alterations insofar as they come within the scope of the appended claims or the equivalents thereof.

1. A medical system (10) to calculate holistic financial risks to caregiving facilities, said medical system (10) comprising:
at least one processor (40) programmed to:
receive healthcare data for a caregiving facility;
receive a first set of one or more key performance indicators (KPIs) relating regulatory data to financial risk to the caregiving facility from government regulations;
receive a second set of one or more KPIs relating non-regulatory data to financial risk to the caregiving facility from one or more sources other than government regulations; and
simultaneously apply the first and second sets of KPIs to the healthcare data to determine a net risk from both government regulations and other sources of financial risk.

2. The medical system (10) according to claim 1, wherein the at least one processor (40) is maintained and operated by a second caregiving facility, and wherein the caregiving facility is different than the second caregiving facility.

3. The medical system (10) according to either one of claims 1 and 2, wherein the healthcare data is historical.

4. The medical system (10) according to any one of claims 1-3, wherein the healthcare data includes all, or a subset of, publicly available data covering healthcare market, healthcare operations, claims and demography.

5. The medical system (10) according to any one of claims 1-4, wherein the healthcare data includes all, or a subset of, hospital specific information that is proprietary to the caregiving facility.

6. The medical system (10) according to any one of claims 1-5, wherein the healthcare data includes all, or a subset of, structured and non-structured data collected through interviews, surveys and auditing of the caregiving facility.

7. The medical system (10) according to any one of claims 1-6, wherein the other sources of financial risk include clinical risk.

8. The medical system (10) according to any one of claims 1-7, wherein the other sources of financial risk include operational and enterprise financial risk.

9. The medical system (10) according to any one of claims 1-8, wherein the healthcare data is customized to determine the net risk for a future or fictitious scenario.

10. The medical system (10) according to any one of claims 1-9, wherein the at least one processor (40) is further programmed to:
simultaneously apply the first set of KPIs and the second set of KPIs to the healthcare data to determine a confidence range for the net risk or trend of a value of the net risk.

11. The medical system (10) according to any one of claims 1-10, wherein the KPIs of the first set of KPIs and/or the second set of KPIs include corresponding sets of one or more actions, and wherein actions of the sets alter the corresponding KPIs.

12. The medical system (10) according to claim 11, wherein the at least one processor (40) is further programmed to:
optimize over all the actions of the sets to determine an action which reduces the net risk by the greatest extent; and
recommend the action to a user of the medical system (10).

13. A method (50) to calculate holistic financial risks to caregiving facilities, said medical method (50) comprising:
receiving (52) healthcare data for a caregiving facility;
receiving (54) a first set of one or more key performance indicators (KPIs) relating regulatory data to financial risk to the caregiving facility from government regulations;
receiving (56) a second set of one or more KPIs relating non-regulatory data to financial risk to the caregiving facility from one or more sources other than government regulations; and
simultaneously applying (58) the first and second sets of KPIs to the healthcare data to determine a net risk from both government regulations and other sources of financial risk.

14. The method (50) according to claim 13, wherein the healthcare data includes at least one of public data, proprietary data and survey data.

15. The method (50) according to either one of claims 13 and 14, wherein the other sources of financial risk include at least one of clinical risk, operational and enterprise financial risk.

16. The method (50) according to any one of claims 13-15, further including:
simultaneously applying the first set of KPIs and the second set of KPIs to the healthcare data to determine a confidence range for the net risk or trend of a value of the net risk.

17. The method (50) according to any one of claims 13-16, wherein the KPIs of the first set of KPIs and/or the second set of KPIs include corresponding sets of one or more actions, wherein actions of the sets alter the corresponding KPIs, and wherein said method further includes:
optimizing over all the actions of the sets to determine an action which reduces the net risk by the greatest extent; and
recommending the action to a user of the medical system (50).

18. One or more processors (40) programmed to perform the method (50) according to any one of claims 13-17.

19. A non-transitory computer readable medium (38) carrying software which contains one or more processors (40) to perform the method (50) according to any one of claims 13-17.

20. A medical system (10) to calculate holistic financial risks to caregiving facilities, said medical system (10) comprising:
a source database including available healthcare data for the present time;
a historical database including historical instances of the healthcare data of the source database;
one or more key performance indicators (KPIs) relating various data from the source database or the historical database to financial outcomes; and
a set of actions controlling the one or more KPIs.
